(19) United States
(12) Patent Application Publication
(10) Pub. No.: US 2005/0166697 A1
(43) Pub. Date: Aug. 4, 2005

(54) Gearing element and motor vehicle gear unit

(76) Inventor: Detles Schnitzer, Denkendorf (DE)

Correspondence Address: KLAUS J. BACH, 4407 TWIN OAKS DRIVE, MURRYSVILLE, PA, 15668, US

(21) Appl. No.: 11/061,309

(22) Filed: Feb. 18, 2005

Related U.S. Application Data
(63) Continuation-in-part of application No. PCT/EP03/08626, filed on Aug. 8, 2003.

(30) Foreign Application Priority Data
Aug. 21, 2002 (DE) 102 38 233.6

(51) Int. Cl. F16H 1/08

(52) U.S. Cl. 74/462

(57) ABSTRACT

In a gearing element with at least first and second adjacent coaxial gear structures formed thereon for at least two different transmission gear sets, specifically a reverse gear and a first forward gear, the gear structures are formed so as to change one into the other, each gear structure having a modulus different from that of the other.

This is a Continuation-in-Part application of International Application PCT/EP03/08626 filed Aug. 8, 2003 and claiming the priority of German application 102 38 233.6 filed Aug. 21, 2002.

### BACKGROUND OF THE INVENTION

The invention relates to a gearing element with at least two gear structures for different gear units particularly for a reverse gear and a first gear stage of an automotive transmission.

DE 199 04 479 A1 discloses such a transmission element, or respectively, an intermediate gear shaft for a motor vehicle transmission. The intermediate gear shaft includes a forward gear and a second gear structure formed from the shaft for a reverse gear, wherein the intermediate gear shaft has, in the area of the reverse gearing, a smaller diameter gear structure than in the area of the gearing for the forward gear. Between the gear structures, a working space is provided by which the gear structures are separated from each other.

It is the object of the present invention to provide a gearing element which, with the same construction space requirements, has increased rigidity.

### SUMMARY OF THE INVENTION

In a gearing element with at least first and second adjacent coaxial gear structures formed thereon for at least two different transmission gears, specifically a reverse gear and a first forward gear, the gear structures are formed so as to change one into the other, each gear structure having a modulus different from that of the other.

The gearing element includes tooth structures which change one into the other and have different modules, that is, different ratios between diameter and number of teeth. There is no intermediate gap between the gear structures whereby space requirements and rigidity are improved particularly if the gear structures are continuous that is if they change infinitely one into the other. Also notch effects can be essentially avoided. Furthermore, the gear structures can be manufactured efficiently in a single mounting setup so that their positions are not changed for the cutting of the two gear structures whereby a particularly accurate relationship between the gear structures is obtained.

The gear structures may have different numbers of teeth; particularly one gear structure may have a number of teeth which is an integral multiple of the number of teeth of the other gear structure. However, preferably, the gear structures have the same number of teeth whereby they can be manufactured in a particularly simple and inexpensive way, especially in a continuous manufacturing process.

In another embodiment, the gear element may be in the form of an intermediate gear shaft. Additional component assembly efforts and expenses can be saved. The gear element may also in the form of a spur gear structure which is firmly mounted on a shaft or an axle, particularly an intermediate shaft for rotation therewith, or is rotatably mounted on the shaft.

The gear structure for the reverse gear may have a smaller module than the gear structure for the first forward gear whereby comfortable forward and reverse drive speeds can be achieved. Specifically, it may be advantageous to provide for a reverse gear a transmission ratio which provides for a smaller/equal or respectively, larger/equal forward gear speed of a first forward gear. The gear speed of the transmission of the motor vehicle can be increased, which, with the same space requirements and weight, increases the efficiency of the motor vehicle transmission.

The arrangement according to the invention can be utilized in connection with various motor vehicle transmissions, however, is particularly advantageous for use in truck transmissions in which, with a stable, space saving design, reverse gear transmission ratios can be obtained which are advantageous for reverse driving with a trailer coupled to the truck.

If the gear structures are produced by a milling or by a grinding procedure, gear structures for a first forward drive gear and for a reverse drive gear with the high number of teeth or numbers of teeth generally required for such applications can be obtained in an efficient high-quality manufacturing process. However, also other manufacturing methods which appear to be reasonable to a person skilled in the art may be employed, for example, instead of being ground, the teeth may be scraped.

The invention will be described below in greater detail on the basis of the accompanying drawing.

### BRIEF DESCRIPTION OF THE DRAWINGS

FIG. 1 shows a section of a gear element in the form of an intermediate shaft of a transmission of a truck.

### DESCRIPTION OF A PREFERRED EMBODIMENT

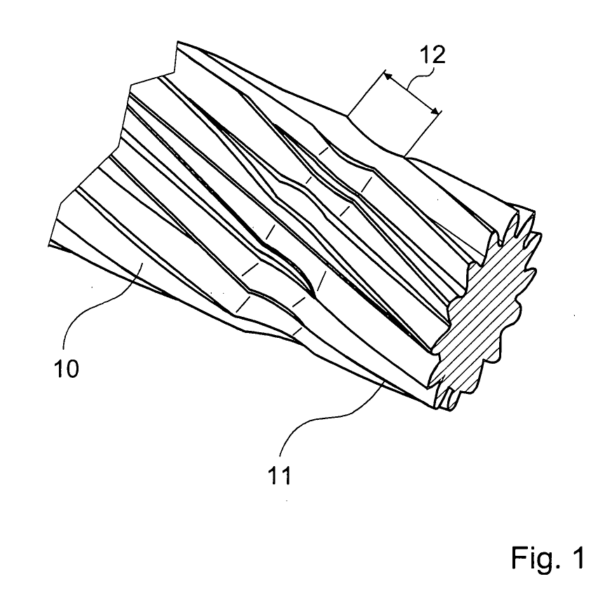

FIG. 1 shows part of a gear element in the form of an intermediate shaft of a truck transmission with a first gear structure 10 for a first forward gear and a second gear structure 11 for a reverse gear.

The gear structures 10, 11 are designed so as to change one into the other with a transition area 12 formed therebetween in which the intermediate shaft becomes conically continuously smaller in diameter. The gear structure 11 for the reverse gear has a smaller modulus than the gear structure 10 for the first forward gear. That is, the modulus of the gear structure 11 for the reverse gear is about 4.73 and the modulus of the gear structure 10 for the first forward gear is about 5.09. The gear structures 10, 11 have the same number of teeth wherein the intermediate shaft has a smaller diameter in the area of the gear structures 10 for the forward gear. The truck transmission includes a reverse gear transmission ratio which provides for a lower vehicle speed than the forward gear transmission ratio of the first forward gear.

The gear structures 10, 11 are manufactured by a metal milling procedure and a subsequent grinding procedure of for example an intermediate shaft while the shaft is being held in a chuck.

1. A gearing element with at least first and second coaxial gear structures (10, 11) formed thereon for at least two different transmission gears, specifically a reverse gear and a first forward gear, said gear structures changing one into the other and each having a modulus different from that of the other.

2. A gearing element according to claim 1, wherein the gear structures (10, 11) change continuously one into the other.

3. A gearing element according to claim 1, wherein the gear structures have the same number of teeth.

4. A gearing element according to claim 1, wherein the gear structures are formed on an intermediate shaft of a transmission.

5. A gearing element according to claim 1, wherein the first gear structure (10) is for a first forward gear and the second (11) is for reverse gear and the second gear structure has a smaller modulus than the first gear structure.

6. A gearing element according to claim 1, wherein the gear structures (10, 11) are manufactured in a single mounting setup.

7. A gearing element according to claim 1, wherein the gear structures are manufactured by a milling- and a subsequent grinding procedure.

8. A motor vehicle transmission with a gearing element according to claim 5, wherein the reverse gear structure (11) is provided for a lower speed transmission ratio than the first forward gear structure (10).
